(19) United States
(12) Patent Application Publication
(10) Pub. No.: US 2015/0210146 A1
(43) Pub. Date: Jul. 30, 2015

(54) VEHICLE DOOR SUPPORT DEVICE

(71) Applicant: Johnson Controls Technology Company, Holland, MI (US)

(72) Inventors: Jason M. Hipshier, Hudsonville, MI (US); Kyle B. Beeck, Grand Haven, MI (US); Andrew Robert Butz, Holland, MI (US)

(21) Appl. No.: 14/418,058

(22) PCT Filed: Jul. 31, 2013
(86) PCT No.: PCT/US2013/053010

§ 371 Date: Jan. 28, 2015

Related U.S. Application Data
(60) Provisional application No. 61/678,922, filed on Aug. 2, 2012.

(51) Int. Cl. B60J 5/04; B60R 7/04

(52) U.S. Cl. CPC B60J 5/0461; B60R 7/046; B60J 5/048; B60J 5/0493; B60J 5/0458

(57) ABSTRACT

A support device for a door of a motor vehicle. One vehicle door assembly includes a first structure and a second structure positioned opposite from the first structure. The vehicle door assembly also includes a flexible support device coupled to the first and second structures. The flexible support device is configured to block movement of the first structure away from the second structure, and to enable movement of the first structure toward the second structure.

### CROSS REFERENCE TO RELATED APPLICATION

This application claims priority from and the benefit of U.S. Provisional Application Ser. No. 61/678,922, entitled “VEHICLE DOOR SUPPORT DEVICE”, filed Aug. 2, 2012, which is hereby incorporated by reference in its entirety.

### BACKGROUND

The invention relates generally to motor vehicles, and more particularly, to a support device for a door assembly of a motor vehicle.

A door assembly of a motor vehicle generally includes various structures that are designed to promote structural integrity of the door assembly. In addition, safety features are integrated into the design of the door assembly. For example, portions of the door assembly may be designed to crush upon impact during a collision, yet maintain a desired shape during normal operation of the vehicle. Unfortunately, certain devices that provide structural integrity are too rigid and inflexible to provide the desired energy management during an impact.

### BRIEF DESCRIPTION OF THE INVENTION

The present invention relates to a vehicle door assembly including a first structure and a second structure positioned opposite from the first structure. The vehicle door assembly also includes a flexible support device coupled to the first and second structures. The flexible support device is configured to block movement of the first structure away from the second structure, and to enable movement of the first structure toward the second structure.

The present invention also relates to a vehicle door assembly including a first structure and a second structure positioned opposite from the first structure. The vehicle door assembly also includes a device extending between the first and second structures. The device is configured to block movement of the first structure away from the second structure, and to enable movement of the first structure toward the second structure.

The present invention further relates to a vehicle door assembly including a flexible support strap extending between a first structure and a second structure. The flexible support strap is configured to block movement of the first structure away from the second structure, and to enable movement of the first structure toward the second structure.

### DRAWINGS

FIG. 1 is a perspective view of an exemplary vehicle that may include a support device in a door assembly of the vehicle.

FIG. 2 is a cross-sectional side view of an embodiment of a vehicle door assembly, which includes a support device.

FIG. 3 is a perspective view of an embodiment of an open storage compartment, which includes a support device.

FIG. 4 is a perspective view of an embodiment of a support device.

### DETAILED DESCRIPTION

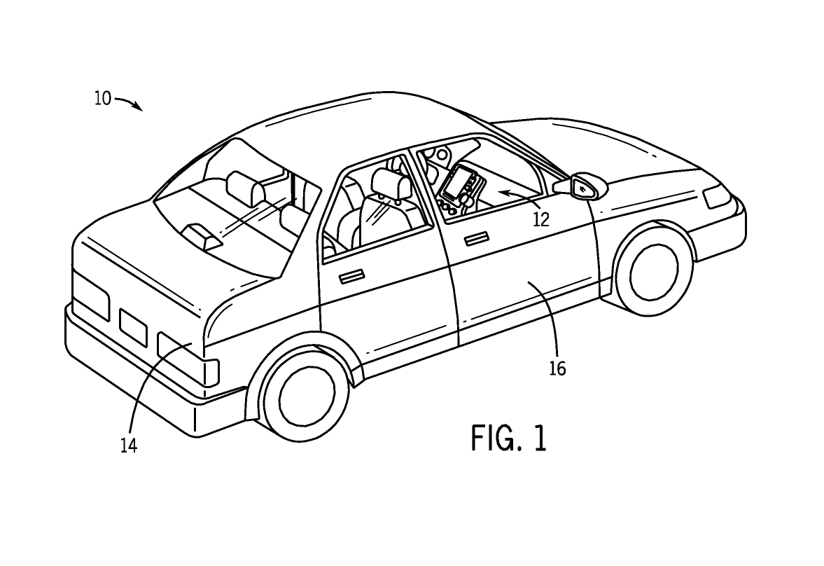

FIG. 1 is a perspective view of an exemplary vehicle 10 that may include a support device in a door assembly of the vehicle. The vehicle 10, in this case a car, includes an interior 12 and an exterior 14. Furthermore, the vehicle 10 includes one or more door assemblies 16. As may be appreciated, a portion of each door assembly 16 is exposed to the interior 12 of the vehicle 10, and a portion of each door assembly 16 is exposed to the exterior 14 of the vehicle 10. Certain door assemblies 16 may include a support device that provides structural integrity during normal operation, and enables the door assembly 16 to crush during an impact. Such a support device may include a flexible support strap, such as a strap made from a webbed nylon material (e.g., seat belt material). The support device may extend between a first structure and a second structure, and may be configured to block movement of the first structure away from the second structure, and to enable movement of the first structure toward the second structure. As such, the support device may provide structural integrity to the door assembly 16, and enable the door assembly 16 to exceed applicable safety standards associated with impact energy management.

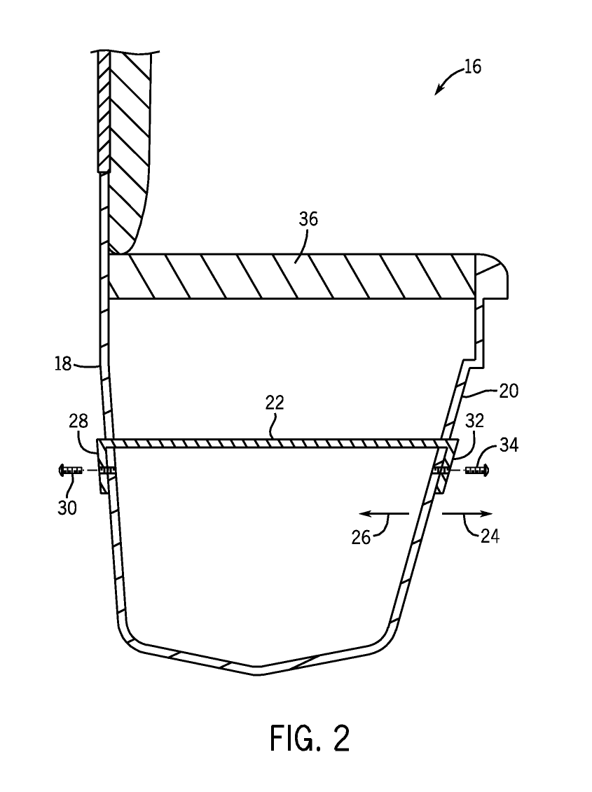

FIG. 2 is a cross-sectional side view of an embodiment of the vehicle door assembly 16, which includes a support device. The vehicle door assembly 16 includes a first structure 18 and a second structure 20. As illustrated, the first and second structures 18 and 20 may extend substantially parallel to one another. A support device 22 is coupled to the first structure 18, and to the second structure 20. The support device 22 may be any suitable flexible device, such as a flexible support strap manufactured from a webbed nylon material similar to the material used to manufacture seat belts, a molded strap, a die cut strap, a knit strap, and so forth. The support device 22 extends between the first structure 18 and the second structure 20, and limits the maximum distance between the first structure 18 and the second structure 20. Further, the support device 22 is configured to block movement of the second structure 20 away from the first structure 18, as illustrated by arrow 24. In addition, the support device 22 is configured to enable movement of the second structure 20 toward the first structure 18, as illustrated by arrow 26. As illustrated, the support device 22 is substantially flat (e.g., formed from a sheet of material), and is positioned horizontally. In other embodiments, the substantially flat support device 22 may be positioned vertically.

A first end 28 of the support device 22 is coupled to the first structure 18. The first end 28 of the support device 22 may be coupled to the first structure 18 in any suitable manner. For example, the first end 28 of the support device 22 may be coupled to the first structure 18 via one or more fasteners 30. In other embodiments, the first end 28 of the support device 22 may be coupled to the first structure 18 via heat staking. Likewise, a second end 32 of the support device 22 is coupled to the second structure 20. The second end 32 of the support device 22 may be coupled to the second structure 20 in any suitable manner. For example, the second end 32 of the support device 22 may be coupled to the second structure 20 via one or more fasteners 34. In other embodiments, the second end 32 of the support device 22 may be coupled to the second structure 20 via heat staking.

In the present embodiment, an armrest 36 may be mounted above the support device 22. For example, the armrest 36 may be positioned to cover the support device 22. In other embodiments, there may be a covering over the support device 22 in place of the armrest 36, or there may be no covering over the support device 22 such that the support device 22 is visibly exposed. By having the support device, the first structure 18 and the second structure 20 are supported against laterally outward movement without affecting the ability of the first and second structures 18 and 20 to crush during an impact.

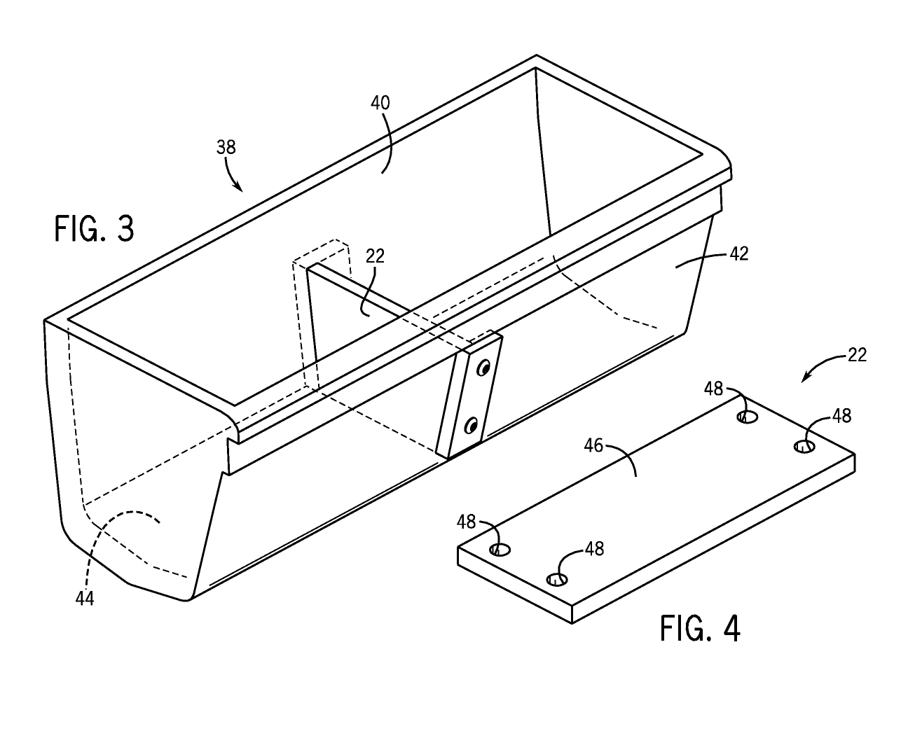

FIG. 3 is a perspective view of an embodiment of an open storage compartment 38, which includes the support device 22. As may be appreciated, the open storage compartment 38 may be part of the vehicle door assembly 16. The open storage compartment 38 includes a first side wall 40, a second side wall 42, and a bottom portion 44 that form a cavity for storing items. As illustrated, the open storage compartment 38 includes the support device 22 extending between the first side wall 40 and the second side wall 42. The support device 22 is configured to provide structural support to the first side wall 40, and to the second side wall 42. The support device 22 may be configured to block movement of the first side wall 40 away from the second side wall 42, and to enable movement of the first side wall 40 toward the second side wall 42. Accordingly, the support device 22 may facilitate inward crushing of the first side wall 40 and/or the second side wall 42 during an impact.

In the illustrated embodiment, the support device 22 may be formed from a sheet of material, or any other suitable material, and is positioned vertically. In other embodiments, the support device 22 may be positioned horizontally or at any other suitable orientation. As may be appreciated, the support device 22 may be coupled to an inner surface of the open storage compartment 38 as illustrated, or the support device 22 may be coupled to an outer surface of the open storage compartment 38. Furthermore, the support device 22 may function as a divider within the open storage compartment 38. Thus, the support device 22 may not only structurally support the open storage compartment 38, but may provide additional functionality. The support device 22 may also include a decorative covering disposed around the support device 22 to enhance its visual appearance.

FIG. 4 is a perspective view of an embodiment of the support device 22. As illustrated, the support device 22 includes a flat side 46 having openings 48 for mounting the support device 22 to the first and second structures 18 and 20, or to the first and second walls 40 and 42. As may be appreciated, the support device 22 may include a grommet around each of the openings 48 to reinforce the support device 22. As discussed above, the support device 22 may extend between the first structure 18 and the second structure 20, and may be configured to block movement of the first structure 18 away from the second structure 20, and to enable movement of the first structure 18 toward the second structure 20. As such, the support device 22 may provide structural integrity to the vehicle door assembly 16, and may enable the vehicle door assembly 16 to exceed applicable safety standards associated with impact energy management.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A vehicle door assembly comprising:
a first structure;
a second structure positioned opposite from the first structure; and
a flexible support device coupled to the first and second structures, wherein the flexible support device is configured to block movement of the first structure away from the second structure, and to enable movement of the first structure toward the second structure.

2. The vehicle door assembly of claim 1, wherein the first structure comprises a first wall of a storage compartment, and the second structure comprises a second wall of the storage compartment.

3. The vehicle door assembly of claim 1, wherein the flexible support device is formed from a flexible material.

4. The vehicle door assembly of claim 1, wherein the flexible support device comprises at least one of a nylon material, a webbed material, a molded material, a knit material, and a die cut material.

5. The vehicle door assembly of claim 1, comprising an armrest, wherein the flexible support device is covered by the armrest.

6. The vehicle door assembly of claim 1, comprising a storage compartment, wherein the flexible support device is mounted in the storage compartment.

7. The vehicle door assembly of claim 6, wherein the flexible support device at least partially divides the storage compartment.

8. The vehicle door assembly of claim 1, comprising a decorative material disposed about the flexible support device.

9. The vehicle door assembly of claim 1, wherein the flexible support device comprises a flat sheet of material.

10. The vehicle door assembly of claim 9, wherein the flat sheet of material extends substantially horizontally or substantially vertically.

11. The vehicle door assembly of claim 1, wherein the flexible support device is secured to the first structure, to the second structure, or any combination thereof, via fasteners.

12. The vehicle door assembly of claim 1, wherein the flexible support device is secured to the first structure, to the second structure, or any combination thereof, via heat staking.

13. A vehicle door assembly comprising:
a first structure;
a second structure positioned opposite from the first structure; and
a device extending between the first and second structures, wherein the device is configured to block movement of the first structure away from the second structure, and to enable movement of the first structure toward the second structure.

14. The vehicle door assembly of claim 13, wherein the device comprises a flexible support strap.

15. The vehicle door assembly of claim 14, wherein the flexible support strap comprises at least one of a nylon material, a webbed material, a molded material, a knit material, and a die cut material.

16. The vehicle door assembly of claim 13, wherein the first structure comprises a first wall of a storage compartment, the second structure comprises a second wall of the storage compartment, and the first and second walls extend substantially parallel to one another.

17. A vehicle door assembly comprising:
a flexible support strap extending between a first structure and a second structure, wherein the flexible support strap is configured to block movement of the first structure away from the second structure, and to enable movement of the first structure toward the second structure.

18. The vehicle door assembly of claim 17, wherein the flexible support strap comprises a first end coupled to the first structure, and a second end coupled to the second structure.

19. The vehicle door assembly of claim 17, wherein the flexible support strap is formed from a flexible material.

20. The vehicle door assembly of claim 17, wherein the flexible support strap comprises at least one of a nylon material, a webbed material, a molded material, a knit material, and a die cut material.
